(19) United States
(12) Patent Application Publication
(10) Pub. No.: US 2024/0224059 A1
(43) Pub. Date: Jul. 4, 2024

(54) MULTI-LINK OPERATION BAND ARRANGEMENT METHOD FOR BLUETOOTH AND WI-FI COEXISTENCE

(71) Applicant: Mediatek Inc., Hsin-Chu (TW)

(72) Inventors: Ting-Che Tseng, Hsinchu City (TW); Yen-Shuo Lu, Hsinchu City (TW)

(73) Assignee: Mediatek Inc., Hsin-chu (TW)

(21) Appl. No.: 18/527,348

(22) Filed: Dec. 3, 2023

Related U.S. Application Data
(60) Provisional application No. 63/478,359, filed on Jan. 4, 2023.

(51) Int. Cl. H04W 16/14; H04L 5/00; H04W 76/15

(52) U.S. Cl. CPC H04W 16/14; H04L 5/0012; H04W 76/15

(57) ABSTRACT

A multi-link operation (MLO) band arrangement method for Bluetooth and Wi-Fi coexistence includes linking a Wi-Fi access point (AP) to a Wi-Fi station which is integrated with a Bluetooth system, the Wi-Fi station informing the Wi-Fi access point about at least one adaptive frequency hopping band in Bluetooth connection of the Wi-Fi station, and the Wi-Fi access point communicating with the Wi-Fi station using at least one frequency band selected according to the at least one adaptive frequency hopping band.

### CROSS REFERENCE TO RELATED APPLICATIONS

This application claims the benefit of U.S. Provisional Application No. 63/478,359, filed on Jan. 4, 2023. The content of the application is incorporated herein by reference.

### BACKGROUND

Bluetooth is used for wireless connections between different devices, such as connecting computers and peripheral devices such as printers, keyboards, etc., or allowing a personal digital assistant (PDA) to communicate with other nearby PDAs or computers. Mobile phones with Bluetooth technology can connect to computers, PDAs, hands-free handsets, and other peripheral devices.

According to established standards, Bluetooth can support more powerful long-distance communications to form a wireless local area network. Each Bluetooth master device can maintain 8 connections simultaneously with slave devices. Each device can be configured to continuously announce its presence to nearby devices in order to establish connections. In addition, the connection between the two devices can be password-protected to prevent from being received by other devices.

In recent years, Bluetooth system will plan to extend frequency bands from 2.4 GHz to 5 GHz or 6 GHz. Therefore, adaptive frequency hopping bands of Bluetooth may coexist with Wi-Fi frequency bands, thus a multi-link operation (MLO) band arrangement method is desired to avoid negative interference between Wi-Fi frequency bands and Bluetooth adaptive frequency hopping bands.

### SUMMARY

In an embodiment, a multi-link operation (MLO) band arrangement method for Bluetooth and Wi-Fi coexistence includes linking a Wi-Fi access point (AP) to a Wi-Fi station which is integrated with a Bluetooth system, the Wi-Fi station informing the Wi-Fi access point about at least one adaptive frequency hopping band in Bluetooth connection of the Wi-Fi station, and the Wi-Fi access point communicating with the Wi-Fi station using at least one frequency band selected according to the at least one adaptive frequency hopping band.

In another embodiment, a multi-link operation (MLO) band arrangement method for Bluetooth and Wi-Fi coexistence includes linking a Wi-Fi access point (AP) to a Wi-Fi station which is integrated with a Bluetooth system, the Wi-Fi station accessing the Wi-Fi access point using at least one frequency band in Wi-Fi connection, and the Wi-Fi station using at least one adaptive frequency hopping band for Bluetooth data transmission, the at least one adaptive frequency hopping band being selected according to the at least one frequency band in Wi-Fi connection.

In another embodiment, a multi-link operation (MLO) band arrangement method for Bluetooth and Wi-Fi coexistence includes linking a Wi-Fi access point (AP) to a Wi-Fi station which is integrated with a Bluetooth system, the Wi-Fi station accessing the Wi-Fi access point using at least one frequency band in Wi-Fi connection, and the Wi-Fi station using at least one adaptive frequency hopping band for Bluetooth data transmission with a transmission power reduced according to the at least one frequency band in Wi-Fi connection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of a multi-link operation band arrangement method for Bluetooth and Wi-Fi coexistence according to an embodiment of the present invention.

FIG. 2 is a flow chart of a multi-link operation band arrangement method for Bluetooth and Wi-Fi coexistence according to another embodiment of the present invention.

FIG. 3 is a flow chart of a multi-link operation band arrangement method for Bluetooth and Wi-Fi coexistence according to another embodiment of the present invention.

### DETAILED DESCRIPTION

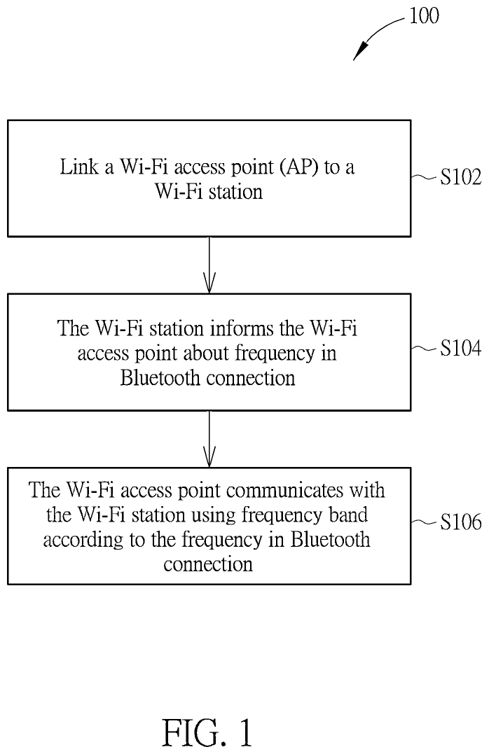

FIG. 1 is a flow chart of a multi-link operation band arrangement method 100 for Bluetooth and Wi-Fi coexistence according to an embodiment of the present invention. The multi-link operation band arrangement method 100 includes the following steps:
Step S102: link a Wi-Fi access point (AP) to a Wi-Fi station which is integrated with a Bluetooth system;
Step S104: the Wi-Fi station informs the Wi-Fi access point about at least one adaptive frequency hopping band in Bluetooth connection of the Wi-Fi station; and
Step S106: the Wi-Fi access point communicates with the Wi-Fi station using at least one frequency band selected according to the at least one adaptive frequency hopping band.

In step S102, the Wi-Fi access point (AP) is linked to the Wi-Fi station integrated with the Bluetooth system via a Wi-Fi connection. The Wi-Fi station is capable of connecting with other devices via Wi-Fi or Bluetooth connection. The frequency band of the Wi-Fi connection can be 2.4 GHz, 5 GHz, or 6 GHz. In step S104, the Wi-Fi station informs the Wi-Fi access point about at least one adaptive frequency hopping band in Bluetooth connection of the Wi-Fi station. The adaptive frequency hopping band in Bluetooth connection of the Wi-Fi station can be 2.4 GHz, 5 GHz, or 6 GHz. In step S106, the Wi-Fi access point communicates with the Wi-Fi station using at least one frequency band selected according to the at least one adaptive frequency hopping band. In an embodiment, the Wi-Fi access point (AP) communicates with the Wi-Fi station using at least one frequency band outside the at least one adaptive frequency hopping band in Bluetooth. That is, if the adaptive frequency hopping band in Bluetooth connection of the Wi-Fi station is 2.4 GHz, then the frequency band of the Wi-Fi connection can be 5 GHz or 6 GHz. If the adaptive frequency hopping band in Bluetooth connection of the Wi-Fi station is 5 GHz, then the frequency band of the Wi-Fi connection can be 2.4 GHz or 6 GHz. If the adaptive frequency hopping band in Bluetooth connection of the Wi-Fi station is 6 GHz, then the frequency band of the Wi-Fi connection can be 2.4 GHz or 5 GHz.

In an embodiment, the Wi-Fi access point (AP) is linked to the Wi-Fi station which is integrated with the Bluetooth system using dual band dual concurrent (DBDC). The Wi-Fi station communicates with other Bluetooth devices using Bluetooth connection in 2.4 GHz and 5 GHz bands, and the Wi-Fi access point (AP) communicates with the Wi-Fi station using Wi-Fi in 2.4 GHz and 6 GHz bands. Although the Wi-Fi station utilizes 2.4 GHz in both Wi-Fi and Bluetooth connections, 5 GHz is only used for Bluetooth connections, and 6 GHz is only used for Wi-Fi connections, avoiding the frequency band interference.

In another embodiment, the Wi-Fi station communicates with other Bluetooth devices using Bluetooth connection in 2.4 GHz and 6 GHz bands, and the Wi-Fi access point (AP) communicates with the Wi-Fi station using Wi-Fi in 2.4 GHz and 5 GHz bands. Although the Wi-Fi station utilizes 2.4 GHz in both Wi-Fi and Bluetooth connections, 6 GHz is only used for Bluetooth connections, and 5 GHz is only used for Wi-Fi connections, avoiding the frequency band interference.

In an embodiment, the Wi-Fi access point (AP) is linked to the Wi-Fi station using triple band triple concurrent (TBTC). The Wi-Fi station communicates with other Bluetooth devices using Bluetooth in 2.4 GHz, 5 GHz, and 6 GHz bands, and the Wi-Fi access point (AP) communicates with the Wi-Fi station using Wi-Fi in 2.4 GHz, 5 GHz, and 6 GHz bands.

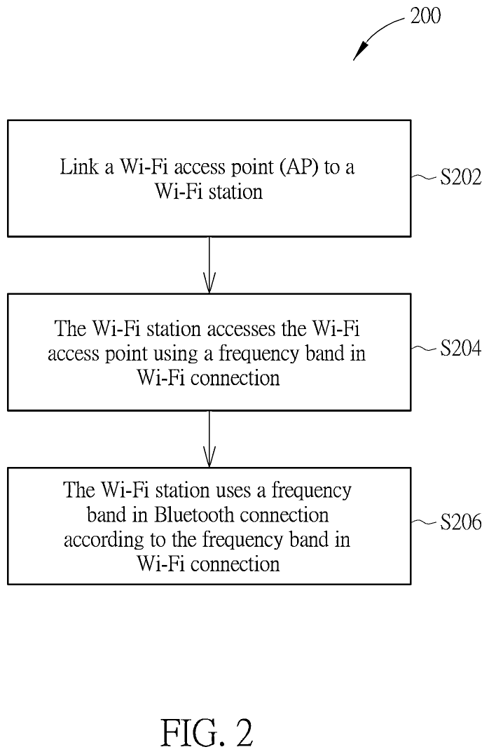

FIG. 2 is a flow chart of a multi-link operation band arrangement method 200 for Bluetooth and Wi-Fi coexistence according to another embodiment of the present invention. The multi-link operation band arrangement method 200 includes the following steps:
Step S202: link a Wi-Fi access point (AP) to a Wi-Fi station which is integrated with the Bluetooth system;
Step S204: the Wi-Fi station accesses the Wi-Fi access point using at least one frequency band in Wi-Fi connection; and
Step S206: the Wi-Fi station uses at least one adaptive frequency hopping band for Bluetooth data transmission, and the at least one adaptive frequency hopping band is selected according to the at least one frequency band in Wi-Fi connection.

In step S202, the Wi-Fi access point (AP) is linked to the Wi-Fi station which is integrated Bluetooth system via a Wi-Fi connection. The frequency band of the Wi-Fi connection can be 2.4 GHz, 5 GHz, or 6 GHz. In step S204, the Wi-Fi station accesses the Wi-Fi access point using at least one frequency band in Wi-Fi connection. In step S106, the Wi-Fi station uses at least one adaptive frequency hopping band for Bluetooth data transmission, and the at least one adaptive frequency hopping band is selected according to the at least one frequency band in Wi-Fi connection. The adaptive frequency hopping band in Bluetooth connection of the integrated Bluetooth can be 2.4 GHz, 5 GHz, or 6 GHz. In an embodiment, the Wi-Fi station communicates with other Bluetooth devices using the at least one adaptive frequency hopping band outside the at least one frequency band in Wi-Fi connection. That is, if the frequency band of the Wi-Fi connection is 2.4 GHz, then the adaptive frequency hopping band in Bluetooth connection of the Wi-Fi station can be 5 GHz or 6 GHz. If the frequency band of the Wi-Fi connection is 5 GHz, then the adaptive frequency hopping band in Bluetooth connection of the Wi-Fi station can be 2.4 GHz or 6 GHz. If the frequency band of the Wi-Fi connection is 6 GHz, then the adaptive frequency hopping band in Bluetooth connection of the Wi-Fi station can be 2.4 GHz or 5 GHz.

In an embodiment, the Wi-Fi access point (AP) is linked to the Wi-Fi station which is integrated the Bluetooth system using dual band dual concurrent (DBDC). The Wi-Fi station communicates with other Bluetooth devices using Bluetooth in 2.4 GHz and 5 GHz bands, and the Wi-Fi access point (AP) communicates with the Wi-Fi station using Wi-Fi in 2.4 GHz and 6 GHz bands. Although the Wi-Fi station utilizes 2.4 GHz in both Wi-Fi and Bluetooth connections, 5 GHz is only used for Bluetooth connections, and 6 GHz is only used for Wi-Fi connections, avoiding the frequency band interference.

In another embodiment, the Wi-Fi station which is integrated with a Bluetooth system communicates with other Bluetooth devices using Bluetooth in 2.4 GHz and 6 GHz bands, and the Wi-Fi access point (AP) communicates with the Wi-Fi station using Wi-Fi in 2.4 GHz and 5 GHz bands. Although the Wi-Fi station utilizes 2.4 GHz in both Wi-Fi and Bluetooth connections, 6 GHz is only used for Bluetooth connections, and 5 GHz is only used for Wi-Fi connections, avoiding the frequency band interference.

In an embodiment, the Wi-Fi access point (AP) is linked to the Wi-Fi station using triple band triple concurrent (TBTC). The Wi-Fi station communicates with other Bluetooth devices using Bluetooth in 2.4 GHz, 5 GHz, and 6 GHz bands, and the Wi-Fi access point (AP) communicates with the Wi-Fi station using Wi-Fi in 2.4 GHz, 5 GHz, and 6 GHz bands.

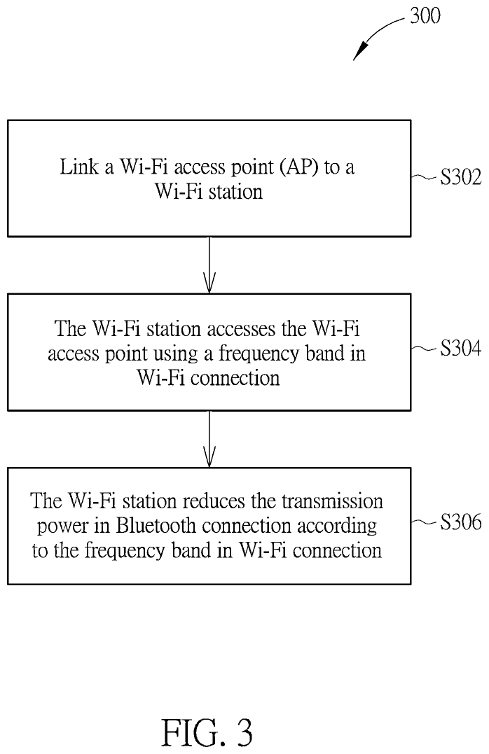

FIG. 3 is a flow chart of a multi-link operation band arrangement method 300 for Bluetooth and Wi-Fi coexistence according to another embodiment of the present invention. The multi-link operation band arrangement method 300 includes the following steps:
Step S302: link a Wi-Fi access point (AP) to a Wi-Fi station which is integrated with the Bluetooth system;
Step S304: the Wi-Fi station accesses the Wi-Fi access point using at least one frequency band in Wi-Fi connection; and
Step S306: the Wi-Fi station uses at least one adaptive frequency hopping band for Bluetooth data transmission with a transmission power reduced according to the at least one frequency band in Wi-Fi connection.

In step S302, the Wi-Fi access point (AP) is linked to the Wi-Fi station which is integrated the Bluetooth system via a Wi-Fi connection. The frequency band of the Wi-Fi connection can be 2.4 GHz, 5 GHz, or 6 GHz. In step S304, the Wi-Fi station accesses the Wi-Fi access point using at least one frequency band in Wi-Fi connection. In step S306, the Wi-Fi station uses at least one adaptive frequency hopping band for Bluetooth data transmission, and the transmission power is reduced according to the at least one frequency band in Wi-Fi connection. The transmission power of Bluetooth is reduced instead of Wi-Fi because the Wi-Fi is used for internet connections, and Bluetooth is used for peripheral device connections which would not affect internet connections. The adaptive frequency hopping band in Bluetooth connection of the Wi-Fi station can be 2.4 GHz, 5 GHz, or 6 GHz.

In an embodiment, the Wi-Fi station which is integrated with the Bluetooth system communicates with other Bluetooth devices using the at least one adaptive frequency hopping band with reduced power when the at least one frequency band in Wi-Fi connection overlaps with the at least one adaptive frequency hopping band. That is, if the frequency band of the Wi-Fi connection is 2.4 GHz, and the adaptive frequency hopping band in Bluetooth connection of the Wi-Fi station is also 2.4 GHz, then the transmission power of the Bluetooth connection is reduced. If the frequency band of the Wi-Fi connection is 5 GHz, and the adaptive frequency hopping band in Bluetooth connection of the Wi-Fi station is also 5 GHz, then the transmission power of the Bluetooth connection is reduced. If the frequency band of the Wi-Fi connection is 6 GHz, and the adaptive frequency hopping band in Bluetooth connection of the Wi-Fi station is also 6 GHz, then the transmission power of the Bluetooth connection is reduced.

In an embodiment, the Wi-Fi access point (AP) is linked to the Wi-Fi station using dual band dual concurrent (DBDC). The Wi-Fi station communicates with other Bluetooth devices using Bluetooth in 2.4 GHz and 5 GHz bands, and the Wi-Fi access point (AP) communicates with the Wi-Fi station integrated with the Bluetooth system using Wi-Fi in 2.4 GHz and 6 GHz bands. Since the frequency band of the Wi-Fi connection and the adaptive frequency hopping band in Bluetooth connection of the Wi-Fi station overlap at 2.4 GHz, the transmission power of the Bluetooth connection is reduced.

In another embodiment, the Wi-Fi station which is integrated with the Bluetooth system communicates with other Bluetooth devices using Bluetooth in 2.4 GHz and 6 GHz bands, and the Wi-Fi access point (AP) communicates with the Wi-Fi station using Wi-Fi in 2.4 GHz and 5 GHz bands. Since the frequency band of the Wi-Fi connection and the adaptive frequency hopping band in Bluetooth connection of the Wi-Fi station overlap at 2.4 GHz, the transmission power of the Bluetooth connection is reduced.

In an embodiment, the Wi-Fi access point (AP) is linked to the Wi-Fi station which is integrated with the Bluetooth system using triple band triple concurrent (TBTC). The Wi-Fi station communicates with other Bluetooth devices using Bluetooth in 2.4 GHz, 5 GHz, and 6 GHz bands, and the Wi-Fi access point (AP) communicates with the Wi-Fi station using Wi-Fi in 2.4 GHz, 5 GHz, and 6 GHz bands. Since the frequency band of the Wi-Fi connection and the adaptive frequency hopping band in Bluetooth connection of the Wi-Fi station overlap at 2.4 GHz, 5 GHz, and 6 GHz, the transmission power of the Bluetooth connection is reduced.

In conclusion, by applying the multi-link operation band arrangement method for Bluetooth and Wi-Fi coexistence according to the embodiments of the present invention, negative interference of frequency band overlapping can be avoided, improving the wireless connections of Wi-Fi and Bluetooth.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-link operation (MLO) band arrangement method for Bluetooth and Wi-Fi coexistence, comprising:
linking a Wi-Fi access point (AP) to a Wi-Fi station integrated with a Bluetooth system;
the Wi-Fi station informing the Wi-Fi access point about at least one adaptive frequency hopping band in Bluetooth connection of the Wi-Fi station; and
the Wi-Fi access point communicating with the Wi-Fi station using at least one frequency band selected according to the at least one adaptive frequency hopping band.

2. The method of claim 1, wherein the frequency band is 2.4 GHz, 5 GHz, or 6 GHz, and the adaptive frequency hopping band is 2.4 GHz, 5 GHz, or 6 GHz.

3. The method of claim 1, wherein the Wi-Fi access point communicating with the Wi-Fi station using the at least one frequency band selected according to the at least one adaptive frequency hopping band is the Wi-Fi access point communicating with the Wi-Fi station using the at least one frequency band outside the at least one adaptive frequency hopping band.

4. The method of claim 1, wherein linking the Wi-Fi access point (AP) to the Wi-Fi station is linking the Wi-Fi access point (AP) to the Wi-Fi station using dual band dual concurrent (DBDC).

5. The method of claim 4, wherein the Wi-Fi station communicates with other Bluetooth stations using Bluetooth in 2.4 GHz and 5 GHz bands, and the Wi-Fi access point (AP) communicates with the Wi-Fi station using Wi-Fi in 2.4 GHz and 6 GHz bands.

6. The method of claim 4, wherein the Wi-Fi station communicates with other Bluetooth stations using Bluetooth in 2.4 GHz and 6 GHz bands, and the Wi-Fi access point (AP) communicates with the Wi-Fi station using Wi-Fi in 2.4 GHz and 5 GHz bands.

7. The method of claim 1, wherein linking the Wi-Fi access point (AP) to the Wi-Fi station is linking the Wi-Fi access point (AP) to the Wi-Fi station using triple band triple concurrent (TBTC), and the Wi-Fi access point (AP) communicates with the Wi-Fi station using Wi-Fi in 2.4 GHz, 5 GHz and 6 GHz bands.

8. A multi-link operation (MLO) band arrangement method for Bluetooth and Wi-Fi coexistence, comprising:
linking a Wi-Fi access point (AP) to a Wi-Fi station integrated with a Bluetooth system;
the Wi-Fi station accessing the Wi-Fi access point using at least one frequency band in Wi-Fi connection; and
the Wi-Fi station using at least one adaptive frequency hopping band for Bluetooth data transmission, the at least one adaptive frequency hopping band being selected according to the at least one frequency band in Wi-Fi connection.

9. The method of claim 8, wherein the frequency band is 2.4 GHz, 5 GHz, or 6 GHz, and the adaptive frequency hopping band is 2.4 GHz, 5 GHz, or 6 GHz.

10. The method of claim 8, wherein the at least one adaptive frequency hopping band is outside the at least one frequency band.

11. The method of claim 8, wherein linking the Wi-Fi access point (AP) to the Wi-Fi station is linking the Wi-Fi access point (AP) to the Wi-Fi station using dual band dual concurrent (DBDC).

12. The method of claim 11, wherein the Wi-Fi station communicates with other Bluetooth stations using Bluetooth in 2.4 GHz and 5 GHz bands, and the Wi-Fi access point (AP) communicates with the Wi-Fi station using Wi-Fi in 2.4 GHz and 6 GHz bands.

13. The method of claim 11, wherein the Wi-Fi station communicates with other Bluetooth stations using Bluetooth in 2.4 GHz and 6 GHz bands, and the Wi-Fi access point (AP) communicates with the Wi-Fi station using Wi-Fi in 2.4 GHz and 5 GHz bands.

14. The method of claim 8, wherein linking the Wi-Fi access point (AP) to the Wi-Fi station is linking the Wi-Fi access point (AP) to the Wi-Fi station using triple band triple concurrent (TBTC), and the Wi-Fi access point (AP) communicates with the Wi-Fi station using Wi-Fi in 2.4 GHz, 5 GHz and 6 GHz bands.

15. A multi-link operation (MLO) band arrangement method for Bluetooth and Wi-Fi coexistence, comprising:
linking a Wi-Fi access point (AP) to a Wi-Fi station integrated with a Bluetooth system;
the Wi-Fi station accessing the Wi-Fi access point using at least one frequency band in Wi-Fi connection; and
the Wi-Fi station using at least one adaptive frequency hopping band for Bluetooth data transmission with a transmission power reduced according to the at least one frequency band in Wi-Fi connection.

16. The method of claim 15, wherein the frequency band is 2.4 GHz, 5 GHz, or 6 GHz, and the adaptive frequency hopping band is 2.4 GHz, 5 GHz, or 6 GHz.

17. The method of claim 15, wherein linking the Wi-Fi access point (AP) to the Wi-Fi station is linking the Wi-Fi access point (AP) to the Wi-Fi station using dual band dual concurrent (DBDC).

18. The method of claim 17, wherein the Wi-Fi station communicates with other Bluetooth stations using Bluetooth in 2.4 GHz and 5 GHz bands, and the Wi-Fi access point (AP) communicates with the Wi-Fi station using Wi-Fi in 2.4 GHz and 6 GHz bands.

19. The method of claim 17, wherein the Wi-Fi station communicates with other Bluetooth stations using Bluetooth in 2.4 GHz and 6 GHz bands, and the Wi-Fi access point (AP) communicates with the Wi-Fi station using Wi-Fi in 2.4 GHz and 5 GHz bands.

20. The method of claim 15, wherein linking the Wi-Fi access point (AP) to the Wi-Fi station is linking the Wi-Fi access point (AP) to the Wi-Fi station using triple band triple concurrent (TBTC), and the Wi-Fi access point (AP) communicates with the Wi-Fi station using Wi-Fi in 2.4 GHz, 5 GHz and 6 GHz bands.
